(19) United States
(12) Patent Application Publication
(10) Pub. No.: US 2006/0216008 A1
(43) Pub. Date: Sep. 28, 2006

(54) Imaging apparatus, solid image sensor, and method for driving the solid image sensor

(75) Inventor: Masakuni Iwanaga, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/387,308

(22) Filed: Mar. 23, 2006

(30) Foreign Application Priority Data
Mar. 25, 2005 (JP) 2005-87394

(51) Int. Cl. G03B 17/00

(52) U.S. Cl. 396/52

(57) ABSTRACT

A dual layered image sensor 2 has a photosensitive layer 21 and an electronic charge transfer layer 22 which has a horizontal transfer gate 23 being connected to an output 24. In such structured image sensor 2, Z transfer which transfers electronic charges from the photosensitive layer 21 to the electronic charge transfer layer 22, and X-Y transfer which transfers the electronic charges in the electronic charge transfer layer 22 in X-Y directions are available. The image sensor 2 is driven to execute a plurality of exposures during an exposure term for image capturing. At each exposure, the photosensitive layer 21 accumulates electronic charges and transfers the accumulated electronic charges to the electronic charge transfer layer 22. Simultaneous with each exposure except 1st one, all electronic charges in the electronic charge transfer layer 22 transferred during the former exposure are transferred in X-Y directions inverse to the directions of shakes on the apparatus body, thus the transferred electronic charges form a blur compensated image. Then, the electronic charges accumulated in the electronic charge transfer layer 22 are obtained line by line via the horizontal transfer gate 23 and the output 24.

### FIELD OF THE INVENTION

The present invention relates to an imaging apparatus, a solid image sensor, and a method for driving the solid image sensor applicable to, for example, digital cameras.

### DESCRIPTION OF THE RELATED ART

Various image-stabilizing methods for digital still cameras have been realized to correct blur in captured images caused by camera shakes. One of typical methods is an optical image shifting which is realized by, for example, movable lenses, variable optical systems such as a vari-angle prism, or the like. According to the optical image shifting, movement of the optical system shifts the light axis toward the image sensor (for example, CCD (Charge Coupled Device) image sensor, a MOS (Metal Oxide Semiconductor) image sensor, a CMOS (Complementary MOS) image sensor, or the like) during exposure, thus images formed on the image sensor are shifted to compensate blur. Another typical method is an image sensor shifting which drives the image sensor to move in order to shift images formed thereon.

To realize effective image compensation against blurry images, those methods require sensors for detecting shakes occurred on the camera body. Usually, for example, a pair of angular rate sensors for detecting shakes in horizontal and vertical directions is installed in a camera body, and an optical system or an image sensor is controlled to move in an appropriate direction based on the detected shakes. Such the methods have been known generally according to, for example, Unexamined Japanese patent application KOKAI publication No. H10-301157.

According to the conventional image-stabilizing methods above, mechanical components are required to drive the optical system or the image sensor. Such the mechanical components occupy extra spaces in a camera, therefore, it is not appropriate for compact cameras. Moreover, since mechanical components are generally fragile by shocks, the reliability of the camera becomes lower as it is used for a long time.

### SUMMARY OF THE INVENTION

In consideration of the aforementioned circumstances, the present invention has been made, and an object of the present invention is to provide an imaging apparatus, a solid image sensor, and a method for driving the solid image sensor which are able to realize more reliable image-stabilization.

In order to achieve the above object, an imaging apparatus according to an aspect of the present invention is an imaging apparatus having a function for preventing blurry images caused by shaken apparatus body, comprises:

a solid image sensor having an electronic charge transferor which comprises 2-dimentionally arrayed multiple electronic charge coupling elements having specific electronic charge coupling elements which accumulate electronic charges of each pixel in an optical image generated by photoelectric conversion, and a horizontal transferor which obtains the accumulated electronic charges in the electronic charge transferor line by line as an image signal;

a driver which drives the solid image sensor with a first drive signal which causes the solid image sensor to execute a plurality of exposures during exposure term for image capturing and a second drive signal which causes the solid image sensor to transfer the electronic charges accumulated in the specific electronic charge coupling elements in vertical and/or horizontal directions;

a shake detector which detects directions and amounts of shakes at the apparatus body, and generates shake information representing the detected directions and amounts of the shakes; and

a controller which controls the driver to generate the second drive signal based on the shake information obtained from the shake detector.

To achieve the above object, a solid image sensor according to another aspect of the present invention is a solid image sensor for converting an optical image into image signals by photoelectric conversion, comprises:

an electronic charge transferor which comprises 2-dimentionally arrayed multiple electronic charge coupling elements having specific electronic charge coupling elements which accumulate electronic charges of each pixel in an optical image generated by photoelectric conversion; and

a horizontal transferor which obtains the accumulated electronic charges in the electronic charge transferor line by line as an image signal, wherein

the solid image sensor is driven during an exposure term by a first drive signal which causes the solid image sensor to execute a plurality of exposures and by a second drive signal which causes the solid image sensor to transfer electronic charges accumulated in the specific charge coupling elements in vertical and/or horizontal directions.

To achieve the above object, a method for driving a solid image sensor according to still another aspect of the present invention is a method for driving a solid image sensor having an electronic charge transferor which comprises 2-dimentionally arrayed multiple electronic charge coupling elements having specific electronic charge coupling elements which accumulate electronic charges of each pixel in an optical image generated by photoelectric conversion, and a horizontal transferor which obtains the accumulated electronic charges in the electronic charge transferor line by line as an image signal, comprises the steps of:

causing the solid image sensor by a first drive signal to execute a plurality of exposures during exposure term for image capturing:

detecting directions and amounts of shakes occurred during the exposure term, and generates shake information representing the detected direction and amounts of the shake;

causing the solid image sensor by a second drive signal based on the shake information to transfer electronic charges accumulated in the specific charge coupling elements every time causing the solid image sensor to execute the plurality of exposures.

According to the present invention, it is able to provide an imaging apparatus having highly reliable image stabilizing function, a solid image sensor to be used for the imaging apparatus, and a method for driving the solid image sensor.

### BRIEF DESCRIPTION OF THE DRAWINGS

These objects and other objects and advantages of the present invention will become more apparent upon reading of the following detailed description and the accompanying drawings in which:

FIG. 1 is a block diagram showing the structure of an imaging apparatus according to the embodiment of the present invention;

FIG. 2 is a schematic diagram for explaining image capturing by the imaging apparatus shown in FIG. 1;

FIG. 3 is a schematic diagram showing the structure of an image sensor in the imaging apparatus shown in FIG. 1;

FIG. 4 is a schematic diagram for explaining electronic charge transfer by the image sensor shown in FIG. 3;

FIG. 5 is a schematic diagram for explaining three-phase drive for the electronic charge transfer;

FIG. 6A is a schematic diagram for explaining an example of vertical transfer;

FIG. 6B is a schematic diagram for explaining an example of horizontal transfer;

FIG. 7 is a timing chart showing voltage changes corresponding to the electronic charge transfer shown in FIGS. 6A and 6B;

FIG. 8A is a schematic diagram for explaining another example of vertical transfer;

FIG. 8B is a schematic diagram for explaining another example of horizontal transfer;

FIG. 9 is a timing chart showing voltage changes corresponding to the electronic charge transfer shown in FIGS. 7A and 7B;

FIG. 10 is a flowchart for explaining image sensor control process executed by a control unit during still image capturing;

FIG. 11 is a timing chart showing actions by the image sensor during still image capturing;

FIG. 12A is a schematic diagram exemplifying state of accumulated electronic charges immediately after 1st exposure;

FIG. 12B is a schematic diagram exemplifying state of accumulated electronic charges immediately after 2nd exposure; and

FIG. 12C is a schematic diagram exemplifying state of accumulated electronic charges immediately after 3rd exposure.

### DETAILED DESCRIPTION OF THE PREFERRED EMBODIMENTS

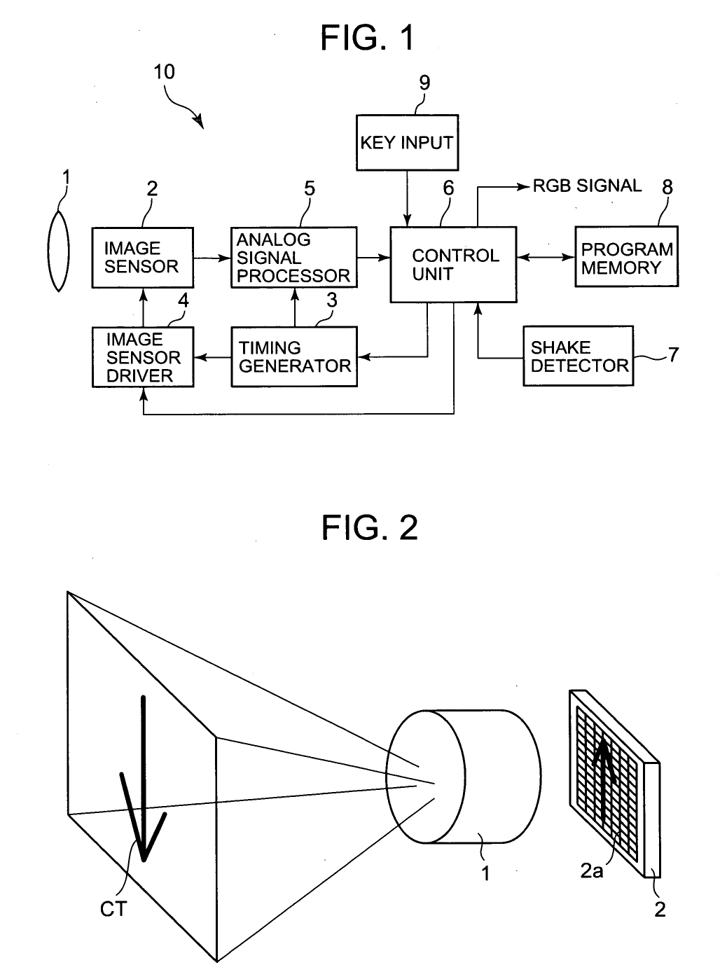

An embodiment of the present invention will now be described with accompanying drawings. In this embodiment, an example where the imaging apparatus according to the present invention is realized as a digital camera for still image capturing (digital still camera). An imaging apparatus of this embodiment according to the present invention will now be described with reference to FIG. 1. FIG. 1 is a block diagram briefly showing the structure of the imaging apparatus 10 of this embodiment according to the present invention which is realized as the digital still camera.

As shown in FIG. 1, the imaging apparatus 10 comprises a lens 1, an image sensor 2, a timing generator 3, an image sensor driver 4, an analog signal processor 5, a control unit 6, a shake detector 7, a program memory 8, and a key input 9.

The lens 1 may be a lens unit having typical lenses for photographing for gathering lights from a target so that an optical image is formed on the image sensor 2. The lens 1 may have, for example, auto-focus function and/or zooming function arbitrary.

The image sensor 2 is a solid image sensor which converts the formed optical image into electric signals by photoelectric conversion, thus image data are generated. In this embodiment, the image sensor 2 may comprise a CCD (Charge Coupled Device) having a dual layer structure (details will be described later).

These lens 1 and the image sensor 2 are major components of the imaging apparatus 10 (hereinafter, referred to as “imaging system”). Principle of imaging by the imaging system of the imaging apparatus 10 will now be described with reference to FIG. 2. FIG. 2 is a diagram schematically showing configuration of the lens 1 and the image sensor 2. As shown in FIG. 2, the lens 1 gathers lights reflected from a capture target CT, and forms up-side-down optical image on a photosensitive surface 2a of the image sensor 2.

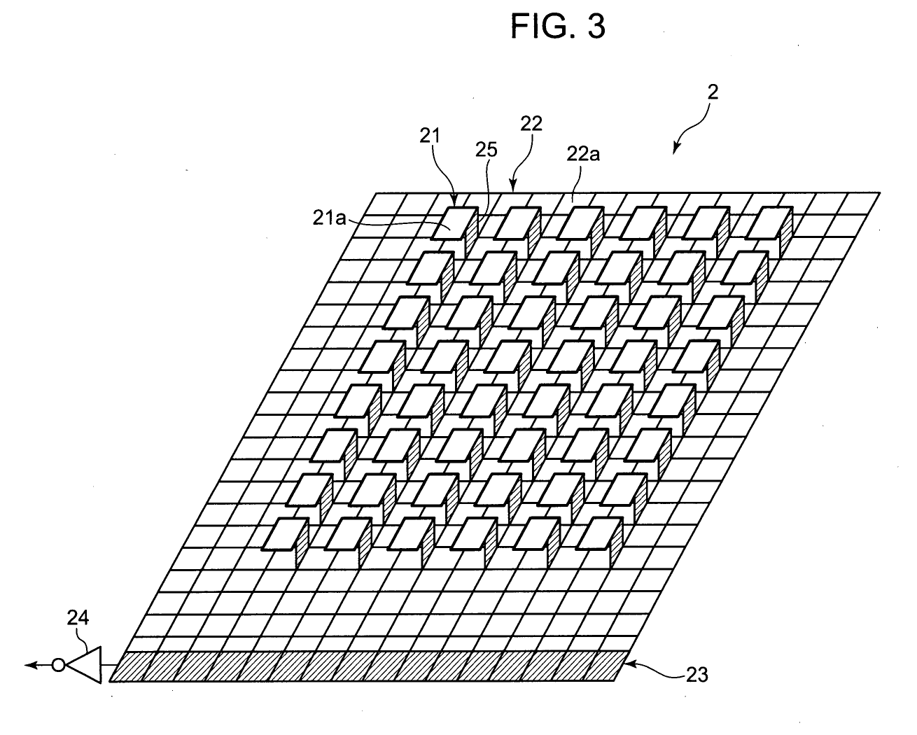

The structure of the image sensor 2 will now be described in detail with reference to FIG. 3. FIG. 3 is a schematic diagram briefly showing the structure of the image sensor 2. As shown in FIG. 3, the image sensor 2 has the dual layer structure having a photosensitive layer 21 and an electronic charge transfer layer 22. The electronic charge transfer layer 22 further comprises a horizontal transfer gate 23 being connected to an output 24 (so-called, frame grabber).

The photosensitive layer 21 is an upper layer above the electronic charge transfer layer 22, and comprises a plurality of 2-dimensionally arrayed photoelectric elements (photo sensors) 21a. The photoelectric elements 21a are arrayed in vertical and horizontal directions (hereinafter, referred to as X-Y directions), that is, matrix arrayed. The photosensitive layer 2a is formed by these photoelectric elements 21a. Additionally, for example, Bayer arrayed RGB color filters (not shown) may be formed on each of the photoelectric elements 21a.

The electronic charge transfer layer 22 beneath the photosensitive layer 21 comprises a plurality of 2-dimensional matrix charge coupling elements 22a (that is, CCD) which are arrayed in vertical and horizontal directions (X-Y directions). The number of the charge coupling elements 22a is larger than that of the photoelectric elements 21a. More precisely, each of the photoelectric elements 21a corresponds to a group of plural charge coupling elements 22a.

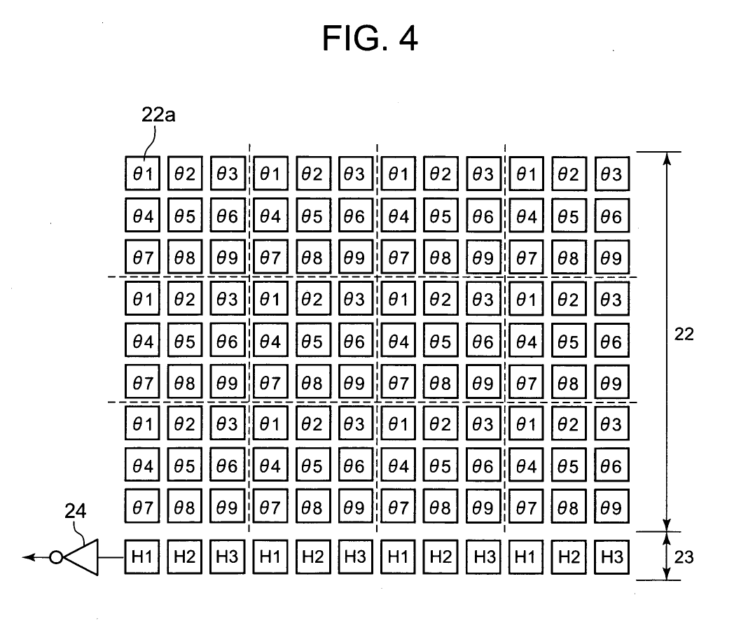

Though FIG. 3 illustrates configuration where each of the photoelectric elements 21a corresponds to a quartet of charge coupling elements 22a as a comprehensive drawing, actual configuration has groups each having 9 (3×3) charge coupling elements 22a each placed at positions θ1 to θ9 being adjacent each other as shown in FIG. 4, and each of such the groups corresponds to each of the photoelectric elements 21a. One of the charge coupling elements 22a in each group is a specific element (for example, the element at θ5) being connected via a read-out gate 25 to the photoelectric element 21a which corresponds to the group.

According to such the structure, electronic charges for all pixels (that is, a whole image) accumulated at the photosensitive layer 21 are transferred downward to the electronic charge transfer layer 22 via the read-out gates 25. In this embodiment, the direction from the photosensitive layer 21 to the electronic charge transfer layer 22 will be referred to as “Z direction”, and the transfer in the Z direction will be referred to as “Z transfer”. Thus transferred electronic charges in the electronic charge transfer layer 22 are further transferred to the horizontal transfer gate 23 sequentially line by line. The horizontal transfer gate 23 further transfers the line unit electronic charges to the output 24 sequentially. Accordingly, packets of the accumulated electronic charges each for 1 horizontal line are constantly available at the output 24 as image signals.

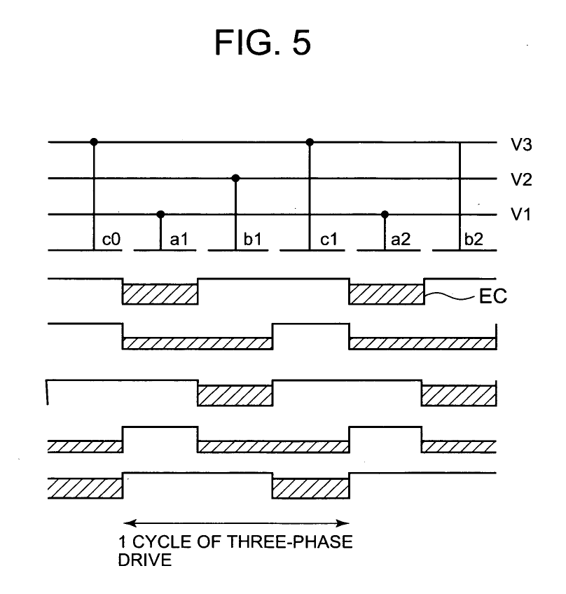

A method of transferring the electronic charges in the electronic charge transfer layer 22 will now be described in detail. In this embodiment, conventional three-phase drive is employed for the transfer. FIG. 5 is a schematic diagram for explaining the electronic charge transfer by the three-phase drive. For the three-phase drive, each of the photoelectric elements 21a has three electrodes for transfer. For example, a first element 21a has transfer electrodes a1, a2 and a3, and a second element 21a has transfer electrodes a2, b2 and c2 (see FIG. 5). In the same manner, each of the photoelectric elements 21a has its own three transfer electrodes respectively.

As shown in FIG. 5, there are three voltage lines V1 to V3 corresponding to each of he three electrodes at each element 21a for applying voltages to each element 21a In this case, #1 electrodes (for example, electrodes a1, a2, . . . ) are connected to the voltage line V1, #2 electrodes (for example, electrodes b1, b2, . . . ) are connected to the voltage line V2, and #3 electrodes (for example, electrodes c1, c2, . . . ) are connected to the voltage line V3. Via such the voltage lines V1 to V3, three-phase drive pulses are applied to each of the photoelectric elements 21a.

When the drive pluses as shown in FIG. 5 are applied to the photoelectric elements 21a via each of the voltage lines V1 to V3, each element 21a transfers the accumulated electronic charges for 1 electrode at every ⅓ cycle of the three-phase drive pulse. In other words, each element 21a transfers the accumulated electronic charges for the three electrodes at every 1 cycle of the three-phase drive pulse.

There are other voltage lines are arranged in the image sensor 2 for applying three-phase drive pulses for vertical transfer and horizontal transfer to the electronic charge transfer layer 22. When the three-phase drive pulses for the vertical transfer are sequentially applied to the electronic charge transfer layer 22, each of the charge coupling elements 22a transfers the electronic charges vertically in the direction toward the horizontal transfer gate 23 or in the inverse direction. Additionally, each of the charge coupling elements 22a is able to transfer the electronic charges horizontally in one direction or in the other direction when the three-phase drive pulses for the horizontal transfer are applied to the electronic charge transfer layer 22.

That is, the electronic charges in the electronic charge transfer layer 22 are flexibly controllable to be transferred in X-Y directions, that is, the vertical direction and the horizontal direction (hereinafter, referred to as “X-Y transfer”) by controlling two kinds of the three-phase drive pulses each for the vertical transfer and the horizontal transfer (hereinafter, referred to as “nine-phase drive signals”).

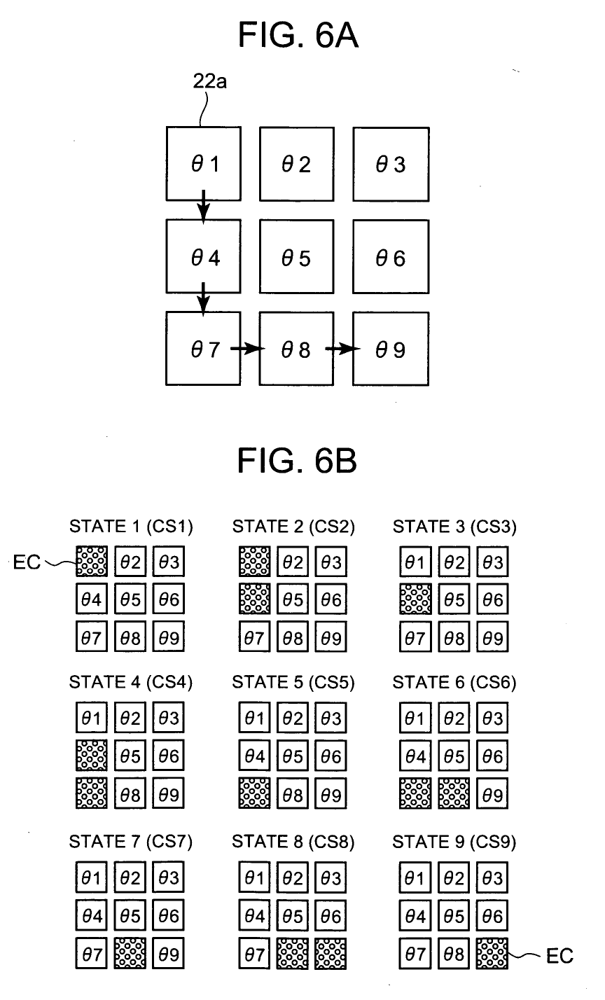

Examples of available patterns for electronic charge transfer realized by the above structure of the image sensor 2 will now be described with reference to FIGS. 6 to 9.

FIGS. 6A and 6B exemplify one of the element groups in the electronic charge transfer layer 22 corresponding to any one of the photoelectric elements 21a. FIG. 6A shows an example of a route of the electronic charge transfer in the group, and FIG. 6B shows states of the electronic charges corresponding to the transfer shown in FIG. 6A.

In this case, the electronic charges EC from the corresponding photoelectric element 21a are accumulated in the charge coupling element 22a at θ1 at beginning, and the electronic charges EC will be transferred to the position θ9 in accordance with the route shown in FIG. 6A, that is, the electronic charges EC are transferred in the order of θ1, θ4, θ7, θ8, and θ9. As the transfer, states of the electronic charges changes as shown in FIG. 6B.

In FIG. 6B, the state at the beginning is represented by state 1 (CS1). Then, the electronic charges EC are transferred to θ4 (state 2 (CS2) and state 3 (CS3)). State 4 (CS4) and state 5 (CS5) correspond to the electronic charges EC being transferred from θ4 to θ7. In the same manner, states of the electronic charges EC being transferred from θ7 to θ8 are represented as state 6 (CS6) and state 7 (CS7), and states along with the transfer from θ8 to θ9 are represented as state 8 (CS8) and state 9 (CS9).

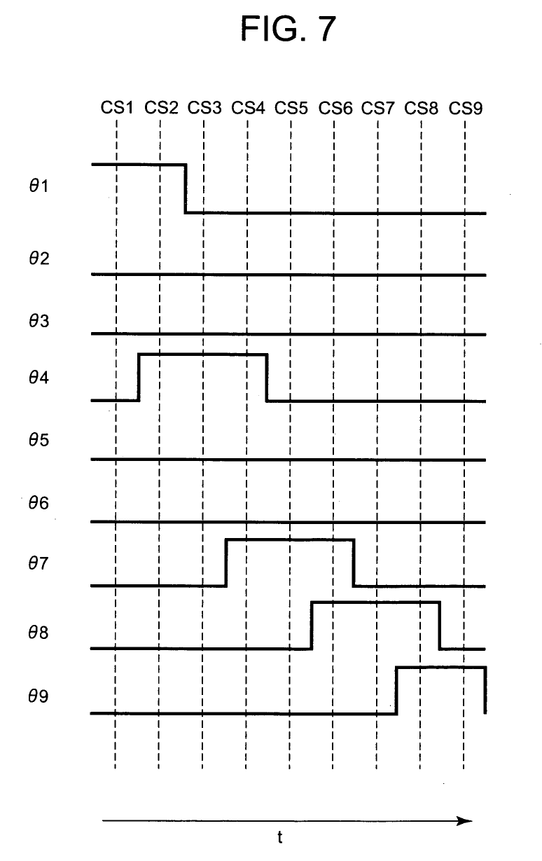

FIG. 7 is a timing chart showing voltages applied to the charge coupling elements 22a at positions θ1 to θ9 being associated with the states of the electronic charges EC (state 1 (CS1) to state 9 (CS9)) shown in FIG. 6B.

In a case where the electronic charges EC are transferred in accordance with the transfer route shown in FIG. 6A, the vertical transfer is carried out twice consecutively, then the horizontal transfer is carried out twice consecutively.

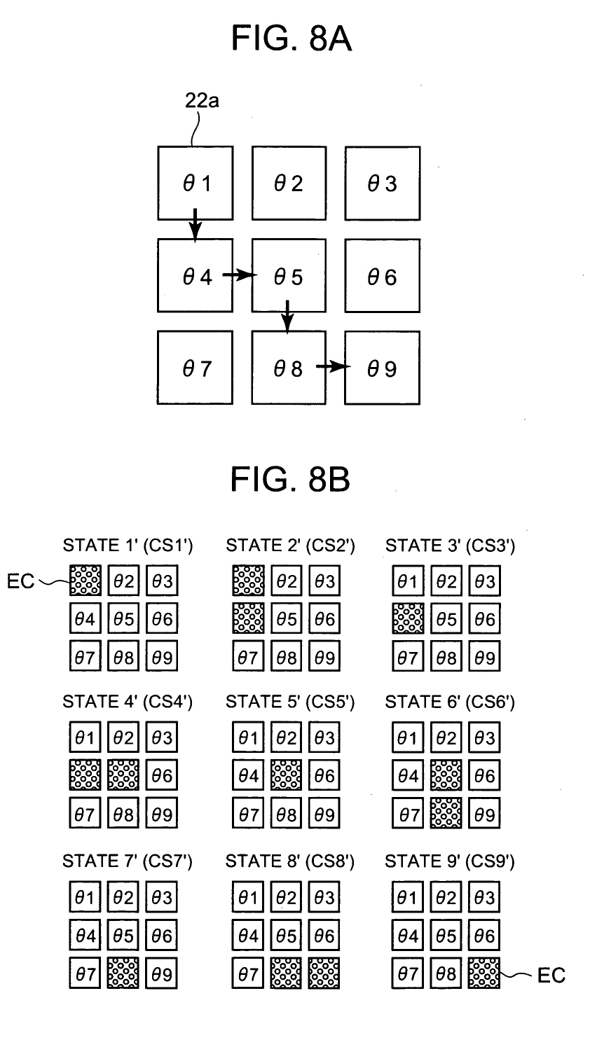

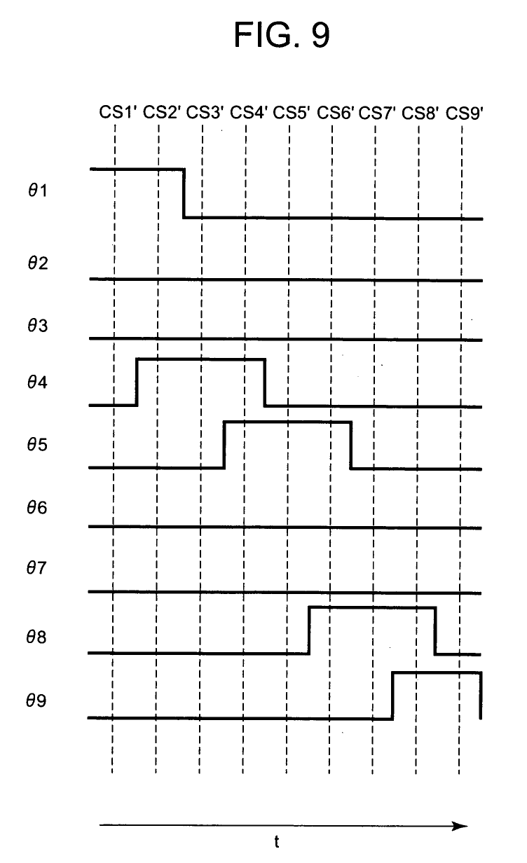

Another example of the electronic charge transfer is shown in FIGS. 8 to 9. Similar to FIGS. 6A and 6B, FIG. 8A shows another example of the transfer route, and FIG. 8B shows states of the electronic charges EC (state 1′ (CS 1′) to state 9′ (CS9′)) in accordance with the transfer route shown in FIG. 8A. Also similar to FIG. 7, FIG. 9 shows voltages being applied to the charge coupling elements 22a being associated with state 1′ (CS 1′) to state 9′ (CS9′) shown in FIG. 8B. In this case, the electronic charges are transferred in the order of θ1, θ4, θ5, θ8, and θ9. That is, the vertical transfer and the horizontal transfer alternate each other and 2 transfer steps are required for each direction respectively.

The image sensor 2 which enables the above flexible transfers is driven by a plurality of drive pulses including the three-phase drive pulses generated by the image sensor driver 4 in accordance with drive timings generated by the timing generator 3 (see FIG. 1).

Thus driven image sensor 2 outputs image signals representing levels of the electronic charges for the pixels of the captured image, to the analog signal processor 5.

The analog signal processor 5 may include an AGC (Auto Gain Control) amplifier, a CDS (Correlated Double Sampling) circuit, an ADC (Analog-Digital Converter), and the like. Such structured analog signal processor 5 adjusts gains of the input image signals from the image sensor 2 with sampling the image signals with using a signal being synchronous with the drive timing given by the timing generator 3, thus the image signals are converted into predetermined bits of digital data. The analog signal processor 5 outputs the digitalized data to the control unit 6 as image data.

The control unit 6 (see FIG. 1) is a computing unit which may comprise a CPU (Central Processing Unit), a memory device such as RAM (Random Access Memory), or the like to execute logical processing, and controls most of the components in the imaging apparatus 10. In this embodiment, the control unit carries out RGB signal processing, thus the image data from the analog signal processor 5 are converted into a plurality of image data sets corresponding to each of RGB. The converted RGB image data are output to a video signal generator (not shown) so as to be converted to video signals. According to the video signals, the captured images may be displayed as, for example, through display for viewfinder on a display device (not shown), or stored in an internal/external storage (not shown) with arbitrary data compression in accordance with predetermined format, for example, JPEG and the like.

The shake detector 7 (see FIG. 1) may comprise sensors to detect shakes occurred on a body of the imaging apparatus 10 (that is, digital camera body). For example, the shake detector 7 may comprise a couple of angular rate sensors each for vertical shake detection and horizontal shake detection, or a plurality of 6-axial gyro sensors as the sensors for detecting the directions (vertical direction and horizontal direction) and the amounts of occurred shakes. The shake detector 7 may include an ADC (Analog-Digital Converter) which converts detection signals from the sensors into digital signals. The shake detector 7 outputs the digitalized shake information to the control unit 6.

The program memory 8 may comprise a ROM (Read Only Memory) or a flash memory for storing programs to be executed by the control unit 6. For example, the program memory 8 stores general programs for usual operations of the digital still camera, such as auto exposure (AE) process. In this embodiment, the program memory 8 stores programs by which the control unit 6, during still image capturing, makes the image sensor driver 4 to generate drive signals corresponding to shakes occurred on the imaging apparatus 10 based on the shake information supplied from the shake detector 7. That is, such the programs make the control unit 6 to function as the drive controller according to the present invention.

The key input 9 may comprise various keys or buttons arranged on the outer surface of the imaging apparatus 10 (digital still camera) including, for example, a power key, a shutter button, and the like. If the any one of the keys is operated by a user, the key input 9 generates input signals (for example, a shutter signal) corresponding to the operation, and inputs the signals to the control unit 6.

According to thus structured imaging apparatus 10 of the present embodiment, the control unit 6 controls the image sensor driver 4 to generate the drive signals, when still image capture is instructed by operation on the shutter key, to control the image sensor 2 so as to execute multi-step exposure (details will be described later).

Note that the above described components are essential ones for realizing the present invention. The imaging apparatus 10 may comprise other components necessary for realizing fundamental or extra functions as well as generally used digital cameras, even if those components are not described or illustrated in this specification or drawings.

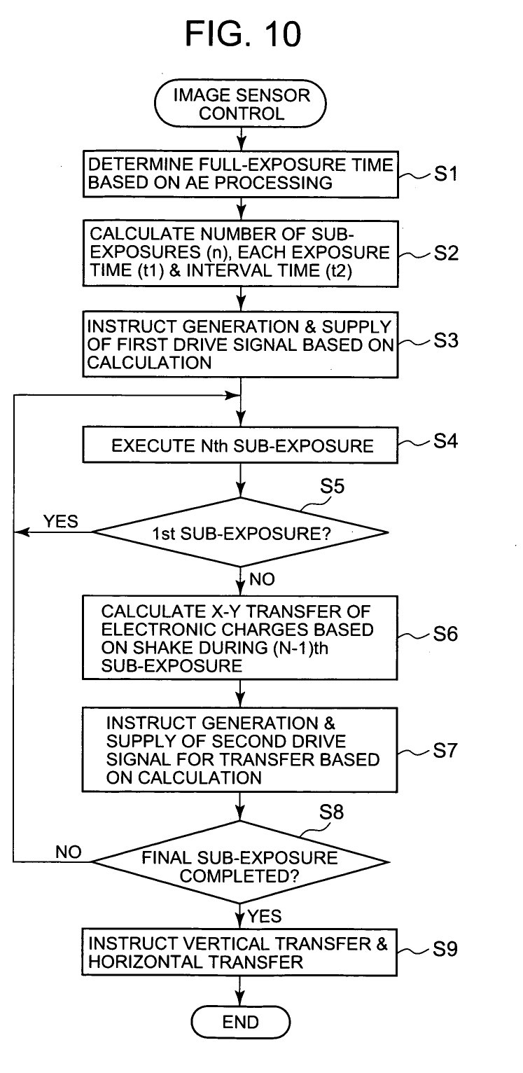

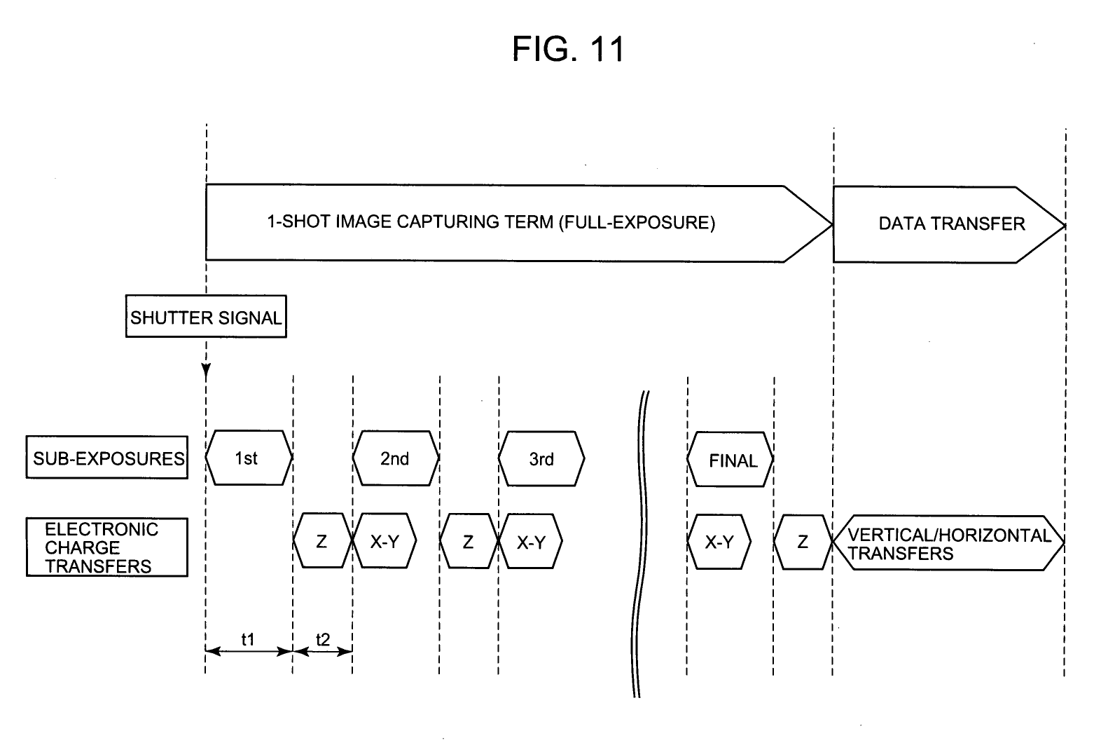

Operations of the imaging apparatus 10 (digital still camera) according to the present embodiment will now be described with reference to accompanying drawings. “Image sensor control” process executed by the control unit 6 during still image capturing, will now be described with reference to FIGS. 10 and 11. FIG. 10 is a flowchart for explaining the image sensor control process, and FIG. 11 is a timing chart showing actions of the image sensor 2 in accordance with the processing. The image sensor control process may start when a shutter signal generated by the key input 9 is input to the control unit 6.

Under the still image capturing mode, the control unit 6 executes the process in response to the shutter signal. First of all, the control unit 6 determines appropriate exposure time (in other words, shutter speed) for complete a still image forming in accordance with 1-shot image capturing (hereinafter, referred to as “full-exposure”) based on the AE processing (step S1).

In this embodiment, the control unit 6 controls the image sensor 2 so as to carry out multi-step exposure. That is, the image sensor 2 carries out a plurality of short-time exposures (hereinafter, referred to as “sub-exposures”) sequentially within the exposure term determined at step S1. The exposure time determined at step S1 represents necessary exposure time for complete a still image by 1-shot image capturing. In this embodiment, the image sensor 2 executes a plurality of sub-exposures within the exposure term to complete the full-exposure. In other words, the image sensor 2 carries out a plurality of photoelectric conversions within the full-exposure term.

To execute the multi-step exposure, the control unit 6 carries out calculation to determine the number of sub-exposures (n), exposure time (t1) for each sub-exposure, and interval time (t2) among the sub-exposures (step S2).

Then, the control unit 6 instructs the image sensor driver 4 to generate a first drive signal based on the calculation at step S2 (step S3). The first drive signal is a drive signals for the photosensitive layer 21. More precisely, the first drive signal causes the photosensitive layer 21 to perform a plurality of photoelectric conversions (electronic charge accumulations) and transfer the accumulated electronic charges in the Z direction to the electronic charge transfer layer 22 (Z transfer). The control unit 6 also instructs the image sensor driver 4 to supply the generated first drive signal to the image sensor 2 (step S3).

According to such the operations, the control unit 6 makes the image sensor 2 to start multi-step exposure (step S4, see FIG. 11). In other words, the image sensor 2 carries out 1st to n-th sub-exposures in accordance with the first drive signal generated by the instruction of the control unit 6. Hereinafter, number of currently executed sub-exposure will be referred to as N (N=1, 2, . . . , n). For example, if the currently executed sub-exposure is 1st sub-exposure, N indicates 1.

The image sensor 2 informs the control unit 6 of each sub-exposure completion. According to the information from the image sensor 2, the control unit 6 counts the completed sub-exposures. If the completed sub-exposure is 1st one (step S5: Yes), the control unit 6 waits for completion of 2nd or later sub-exposures.

If the completed sub-exposure is 2nd or later one (step S5: No), the control unit 6 obtains shake information representing shakes occurred during (N−1)th sub-exposure from the shake detector 7. More precisely, the control unit 6 recognizes the directions and amounts of shakes occurred since beginning of (N−1)th sub-exposure until Nth sub-exposure starts (that is, a term represented by t1+t2).

Based on the shake information for (N−1)th sub-exposure, the control unit 6 calculates transfer of the electronic charges in the electronic charge transfer layer 22 in order to compensate blurry image caused by the shake represented by the shake information (step S6). More precisely, the control unit 6 calculates the directions (X-Y directions) and the number of transfer steps for the compensational electronic charge transfer. In this case, the control unit 6 calculates the directions inverse to the shake direction. The number of transfer steps corresponds to the amount of the shake.

When it comes to a timing where the Z transfer for the former sub-exposure completes, the control unit 6 instructs the image sensor driver 4 to generate a second drive signal and to supply the generated second drive signal to the image sensor 2 (step S7). More precisely, the second drive signal is the aforementioned nine-phase drive signals. The second drive signal is generated based on the results of the calculation at step S6. That is, such the second drive signal causes the electronic charge transfer layer 22 to transfer the electronic charges in the directions (X-Y directions) calculated at step S6 with the amount of transfer according to the number of transfer steps calculated at step S6.

Accordingly, as shown in FIG. 11, the electronic charges in the electronic charge transfer layer 22 are transferred in the vertical and the horizontal directions (X-Y directions) being inverse to the shake directions.

That is, whole of the electronic charges in the electronic charge transfer layer 22 are transferred so that the electronic charges corresponding to an arbitrary light spot in the optical image generated by the former sub-exposure ((N−1)th exposure) are previously transferred to a predicted position where newly accumulated electronic charges corresponding to the arbitrary light spot will be transferred by the next sub-exposure (Nth exposure).

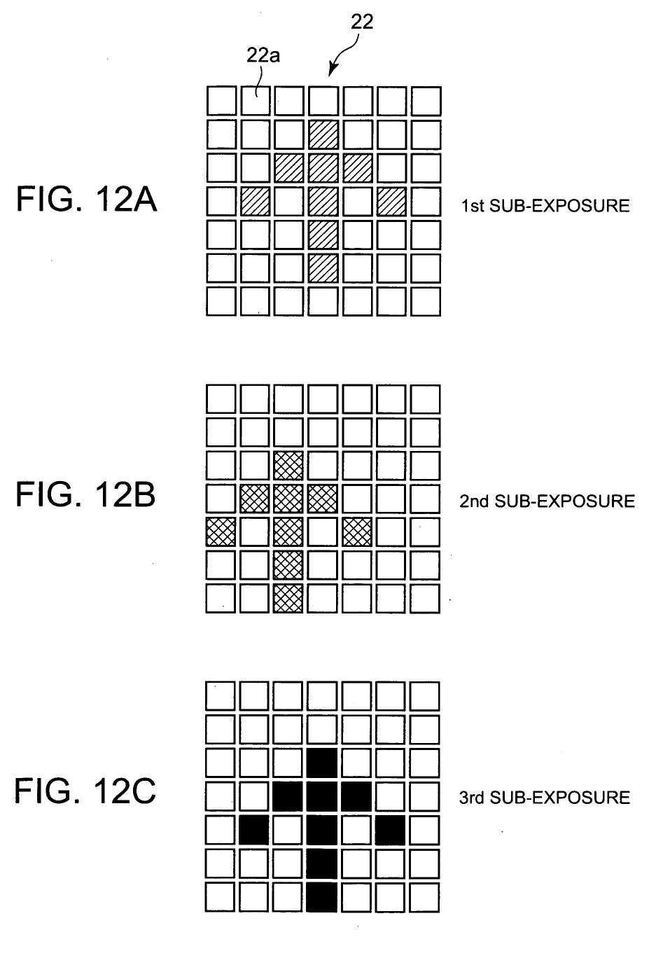

Such the processing at steps S4 to S7 will be executed repeatedly until the final sub-exposure (that is, n-th exposure) is completed (step S8: No). FIGS. 12A to 12C show changes of the optically formed image in accordance with the electronic charge transfer. Note that FIGS. 12A to 12C schematically show the states of accumulated electronic charges immediately after the sub-exposures (including Z transfers) are completed where the number of sub-exposures is 3. For comprehensive illustration, each of FIGS. 12A to 12C shows only the specific charge coupling element 22a being connected to the corresponding photoelectric element 21a via the read-out gate 25. In FIGS. 12A to 12C, hatched elements 22a represents the elements where the electronic charges are transferred.

As shown in FIGS. 12A to 12C, the electronic charges corresponding to the arbitrary light spot on the formed optical image at the photoelectric layer 21 are accumulated at every time the sub-exposures are executed, thus the electronic charges are accumulated at appropriate positions for compensating blurs. As a result, an image finally formed after the multi-step exposure is not a blurry image even if the imaging apparatus 10 (digital still camera) is shaken during the 1-shot still image capturing term.

After the final sub-exposure is completed (step S8: Yes), the control unit 6 instructs the electronic charge transfer layer 22 to transfer the electronic charges vertically to the horizontal transfer gate 23, and instructs the horizontal transfer gate 23 to transfer the electronic charges horizontally to the output 24 (step S9), then terminates the process.

As described above, the imaging apparatus 10 of the embodiment according to the resent invention realizes effective image stabilization only by transferring the electronic charges in the image sensor 2. That is, any mechanical components for stabilizing image are not required for the image stabilization. Since the mechanical components are unnecessary, any compact digital cameras are able to employ the image stabilizing function without any restrictions. Moreover, such the un-mechanical structure brings not only effective image stabilization but also higher reliability of the apparatus.

Noises in the image data after the image stabilization according to the above embodiment are very few rather than a case where a plurality of images captured by a plurality of very short time exposures are synthesized with adjusting blurs, because it is realized only by transferring the electronic charges in the electronic charge transfer layer 22.

In the above described embodiment, since the image sensor 2 employs the dual layer structure having the photosensitive layer 21 and the electronic charge transfer layer 22, it is able to execute X-Y transfers of the electronic charges in the electronic charge transfer layer 22 and next sub-exposure in parallel. Under such the structure, more efficient image capturing is available by shortening the interval time (t2) among the sub-exposures.

Though the above embodiment exemplified the image sensor 2 which enables transfer of all electronic charges in X-Y directions by driving the electronic charge transfer layer 22 with using two kinds of three-phase drive pulses each for the horizontal transfer and the vertical transfer, arbitrary driving methods may be employed. For example, the electronic charge transfer layer 22 may be driven by four-phase driving pulses. In this case, the electronic charge transfer layer 22 may have groups of the charge coupling elements 22a each having 16 (4×4) charge coupling elements 22a corresponding to each of the photoelectric elements 21a.

Instead of the dual layered image sensor 2 described in the above embodiment, a single layered image sensors may also be applicable. For example, the photosensitive layer 21 may be eliminated from the image sensor 2 with applying photoelectric converter function to the electronic charge transfer layer 22. To realize this structure, the electronic charge transfer layer 22 may utilize generally known technique such as full frame CCD (FF-CCD), thus photoelectric converter function is available. According to such the structure, the electronic charge transfer layer 22 performs both the photoelectric conversion and X-Y transfers of the electronic charges. Though this structure eliminates the Z transfers, it is not able to execute the sub-exposures and the X-Y transfers simultaneously. In this case, the sub-exposures should be separated by using a mechanical shutter or the like which allows separated light introductions.

The present invention may be applicable to any image capturing apparatuses where still image capturing function is available. That is, the present invention may be applicable to any imaging apparatuses embedded in any apparatuses, for example, mobile phones or the like.

This application is based on Japanese Patent Application No. 2005-87394 (filed on Mar. 25, 2005), and including specification, claims, drawings and summary. The disclosures of the above Japanese Patent Application are incorporated herein by reference in its entirety.

What is claimed is:

1. An imaging apparatus having a function for preventing blurry images caused by shaken apparatus body, comprising:
a solid image sensor having an electronic charge transferor which comprises 2-dimentionally arrayed multiple electronic charge coupling elements having specific electronic charge coupling elements which accumulate electronic charges of each pixel in an optical image generated by photoelectric conversion, and a horizontal transferor which obtains the accumulated electronic charges in said electronic charge transferor line by line as an image signal;
a driver which drives said solid image sensor with a first drive signal which causes said solid image sensor to execute a plurality of exposures during exposure term for image capturing and a second drive signal which causes said solid image sensor to transfer the electronic charges accumulated in said specific electronic charge coupling elements in vertical and/or horizontal directions;
a shake detector which detects directions and amounts of shakes at said apparatus body, and generates shake information representing the detected directions and amounts of the shakes; and
a controller which controls said driver to generate said second drive signal based on the shake information obtained from said shake detector.

2. The imaging apparatus according to claim 1, wherein
said solid image sensor further comprises a photosensitive portion having 2-dimentionally arrayed multiple photoelectric elements forming pixels as an upper layer above said electronic charge transferor, and
said driver drives said photosensitive portion by said first drive signal to execute photo electric conversion, and to transfer electronic charges generated by the photoelectric conversion of said multiple photoelectric elements of the pixels to said specific charge coupling elements in said electronic charge transferor.

3. The imaging apparatus according to claim 2, wherein
said controller controls said driver to generate said second drive signal while said photosensitive portion of said solid image sensor is being driven by said first drive signal to execute the photoelectric conversion.

4. A solid image sensor for converting an optical image into image signals by photoelectric conversion, comprising:
an electronic charge transferor which comprises 2-dimentionally arrayed multiple electronic charge coupling elements having specific electronic charge coupling elements which accumulate electronic charges of each pixel in an optical image generated by photoelectric conversion; and
a horizontal transferor which obtains the accumulated electronic charges in said electronic charge transferor line by line as an image signal, wherein
said solid image sensor is driven during an exposure term by a first drive signal which causes said solid image sensor to execute a plurality of exposures and by a second drive signal which causes said solid image sensor to transfer electronic charges accumulated in said specific charge coupling elements in vertical and/or horizontal directions.

5. The solid image sensor according to claim 1, further comprising:
a photosensitive portion having 2-dimentianally arrayed multiple photoelectric elements forming pixels as an upper layer above said electronic charge transferor, which transfers electronic charges generated by the photoelectric conversion of said multiple photoelectric elements of the pixels to said specific charge coupling elements in said electronic charge transferor.

6. A method for driving a solid image sensor having an electronic charge transferor which comprises 2-dimentionally arrayed multiple electronic charge coupling elements having specific electronic charge coupling elements which accumulate electronic charges of each pixel in an optical image generated by photoelectric conversion, and a horizontal transferor which obtains the accumulated electronic charges in said electronic charge transferor line by line as an image signal, comprising the steps of:
causing said solid image sensor by a first drive signal to execute a plurality of exposures during exposure term for image capturing:
detecting directions and amounts of shakes occurred during said exposure term, and generates shake information representing the detected direction and amounts of the shake;
causing said solid image sensor by a second drive signal based on said shake information to transfer electronic charges accumulated in said specific charge coupling elements every time causing said solid image sensor to execute the plurality of exposures.
